(19) United States
(12) Patent Application Publication
(10) Pub. No.: US 2011/0244228 A1
(43) Pub. Date: Oct. 6, 2011

(54) CURABLE POLYURETHANE DISPERSIONS

(75) Inventors: Harald Blum, Hafenlohr (DE); Jörg Büchner, Bergisch-Gladbach (DE); Wolfgang Henning, Kreuzau/Untermaubach (DE)

(73) Assignee: Bayer MaterialScience AG, Leverkusen (DE)

(21) Appl. No.: 13/127,924

(22) PCT Filed: Oct. 31, 2009
(86) PCT No.: PCT/EP2009/007802

§ 371 Date: May 5, 2011

(30) Foreign Application Priority Data
Nov. 14, 2008 (EP) 08019884.9

(51) Int. Cl. C08L 75/06; C09J 175/06; C09J 7/02

(52) U.S. Cl. 428/354; 524/591; 428/355 EP; 428/355 N

(57) ABSTRACT

The present invention relates to an aqueous polyurethane or polyurethane-urea dispersion comprising a polyurethane or a polyurethane polyurea dispersed therein, wherein the polyurethane or polyurethane polyurea comprises terminal carboxyl groups and lateral sulfonate and/or carboxylate groups.

The invention relates to aqueous, crosslinkable dispersions based on polyurethane or polyurethane ureas, a process for their production and their use.

Crosslinkable aqueous polyurethane or polyurethane-polyurea dispersions for lacquer, sealant and adhesive applications are known. When such dispersions are used for adhesives, for example, for bonding substrates, the heat activation method is often used. Here the dispersion is applied to the substrate and once the water has completely evaporated the adhesive layer is activated by heating, for example with an infrared heater, and converted to a tacky state. The temperature at which the adhesive film becomes tacky is known as the activation temperature.

To improve the adhesive properties, hydroxy-functional polyurethane or polyurethane-polyurea dispersions are combined with isocyanate-functional crosslinkers, for example. This generally leads to good adhesive properties. Such adhesives based on aqueous polyurethane or polyurethane-polyurea dispersions which are suitable for use of the heat activation method are described for example in U.S. Pat. No. 4,870,129. The disadvantage of such combinations is the relatively short processing time, generally of only a few hours, caused by the reaction of the polyisocyanate crosslinker with the water.

The combination of carboxylate-functional dispersions with carbodiimide-functional crosslinkers is also known. Such binders are described for example in DE-A 199 5 4 500, DE-A 44 10 557 or EP-A 792 908. The dispersions contain carboxylate groups, which are necessary for the dispersibility of the polyurethanes. The carboxylate groups are conventionally incorporated into the polymers by use or incorporation of dimethylol propionic acid and neutralisation of the carboxyl group, for example with volatile amines. However, the reactivity and properties of such binder blends are often not sufficient to meet increased requirements, in particular for use in or as a high-grade adhesive.

U.S. Pat. No. 5,066,705 describes aqueous protective lacquers for plastic substrates based on carboxyl-functional polymers, carboxyl-functional polyurethanes and polycarbodiimides. Both the polymer and the polyurethane have very high acid values, which can be disadvantageous for many applications. For example, elevated amounts of carboxyl groups can lead to an excessively high residual hydrophilicity in the film, which results in a sensitivity to water or other substances. Dimethylol propionic acid or carboxy-functional polyesters are used to incorporate the carboxyl groups into the polyurethane dispersion; both lead to sterically hindered carboxyl groups, which are not optimally accessible to a crosslinking reaction.

EP 1272588 describes an adhesive composition consisting of a complex blend of at least one crystallising polyester-polyurethane dispersion, a polyacrylate copolymer, a polychloroprene dispersion, a heat-curable resin and a suitable stabiliser system consisting of amino alcohol, a carbodiimide and magnesium oxide, wherein the stabiliser system has the function inter alia of suppressing hydrolysis of the polyester and keeping the system stable. For practical applications a multicomponent system of this nature is much too expensive and prone to failure, and a crosslinking reaction in the true sense does not take place.

The object of the present invention was therefore to provide aqueous, crosslinkable dispersions based on polyurethane or polyurethane ureas, which are suitable for producing high-quality lacquers, sealants and in particular adhesives, have a good reactivity and allow long processing times.

The term polyurethane or polyurethane dispersion is also used hereinafter as a synonym for polyurethane and/or polyurea and polyurethane and/or polyurethane-polyurea dispersion.

Surprisingly it has now been found that the crosslinkable aqueous polyurethane or polyurethane-polyurea dispersions described below, optionally in combination with crosslinkers, are suitable as high-grade lacquers, sealants and in particular adhesives, have a very long processing time and lead to high-grade, crosslinked adhesives, lacquers and sealants.

The present invention provides aqueous polyurethane or polyurethane-urea dispersions comprising polyurethanes or polyurethane polyureas dispersed therein having terminal carboxyl groups and additionally lateral sulfonate and/or carboxylate groups.

Even with relatively low concentrations of terminal carboxyl groups the polyurethane dispersions according to the invention have very good crosslinking properties in combination with carboxyl-reactive crosslinkers, and in combination with polycarbodiimides, for example, allow the production of high-grade adhesives, wherein the binder combinations have very long processing times of a few days to several months.

In a preferred embodiment of the invention, the polyurethanes or polyurethane polyureas contained in the dispersions according to the invention additionally contain, in addition to the terminal carboxyl groups, sulfonate groups, at least 70 mol %, preferably 100 mol % of which relative to the content of sulfonate groups are lateral.

In a likewise preferred embodiment of the invention, the polyurethanes or polyurethane polyureas contained in the dispersions according to the invention additionally contain, in addition to the terminal carboxyl groups, carboxylate groups, at least 50%, preferably 70%, and particularly preferably 100% of which are lateral.

In a further preferred embodiment of the invention, the polyurethanes or polyurethane polyureas contained in the dispersions according to the invention additionally contain, in addition to the terminal carboxyl groups, carboxylate and sulfonate groups, at least 50%, preferably 70%, and particularly preferably 100% of which are lateral.

The polyurethanes or polyurethane polyureas contained in the aqueous polyurethane or polyurethane-urea dispersions according to the invention are typically reaction products consisting of

a) at least one component having sulfonate and/or carboxylate groups, which moreover has two or three isocyanate-reactive hydroxyl and/or amino groups and thus leads to lateral sulfonate or carboxylate structural units,

b) at least one diol and/or polyol component,

c) at least one di- and/or polyisocyanate component,

d) at least one aminocarboxylic acid and/or hydroxycarboxylic acid, wherein components d) each have only one hydroxyl or amino group, such that terminal carboxyl groups are obtained,

e) optionally mono-, di- and/or triamino- and/or hydroxy-functional compounds and

f) optionally other isocyanate-reactive compounds.

Component a) is typically used in quantities of 0.5 to 10, preferably 0.75 to 5 wt. %, relative to the anhydrous and solvent-free polyurethane or polyurethane polyurea.

Component b) is typically used in quantities of 20 to 94, preferably 30 to 90 wt. %, relative to the anhydrous and solvent-free polyurethane or polyurethane polyurea.

Component c) is typically used in quantities of 5 to 60, preferably 6 to 45 wt. %, relative to the anhydrous and solvent-free polyurethane or polyurethane polyurea.

Component d) is typically used in quantities of 0.25 to 10, preferably 0.4 to 4 wt. %, relative to the anhydrous and solvent-free polyurethane or polyurethane polyurea.

Component e) is typically used in quantities of 0 to 10, preferably 0 to 5 wt. %, relative to the anhydrous and solvent-free polyurethane or polyurethane polyurea.

Component f) is typically used in quantities of 0 to 20, preferably 0 to 10 wt. %, relative to the anhydrous and solvent-free polyurethane or polyurethane polyurea.

Within the context of the invention it is self-evident that components a) to f) and the typical and preferred quantities thereof described above also include all combinations of the individually specified quantity ranges.

Suitable components a) containing sulfonate or carboxylate groups are for example diamino compounds or dihydroxy compounds additionally bearing sulfonate and/or carboxylate groups, such as for example the sodium, lithium, potassium, tert-amine salts of N-(2-aminoethyl)-2-aminoethanesulfonic acid, N-(3-aminopropyl)-2-aminoethanesulfonic acid, N-(3-aminoproyl)-3-aminopropanesulfonic acid, N-(2-aminoethyl)-3-aminopropanesulfonic acid, analogue carboxylic acids, dimethylol propionic acid, dimethylol butyric acid, the reaction products in accordance with a Michael addition of 1 mol of diamine such as for example 1,2-ethane diamine or isophorone diamine and 2 mol of acrylic acid or maleic acid.

Preferred components a) are N-(2-aminoethyl)-2-aminoethanesulfonate or dimethylol propionate.

The acids are preferably used directly in their salt form as a sulfonate or carboxylate. It is also possible, however, to add all or part of the neutralising agent necessary for salt formation only during or after polyurethane production.

Particularly well suited and preferred tertiary amines for salt formation are for example triethylamine, dimethyl cyclohexylamine, ethyl diisopropylamine.

Other amines can also be used for salt formation, such as for example ammonia, diethanolamine, triethanolamine, dimethylethanolamine, methyl diethanolamine, aminomethylpropanol and also mixtures of the cited and also other amines. It is advisable to add these amines only after the reaction of the isocyanate groups is largely complete.

It is also possible to use other neutralising agents such as for example sodium, potassium, lithium or calcium hydroxide for neutralisation purposes.

Component a) is contained in the polyurethane according to the invention in quantities of 0.5 to 10, preferably 0.75 to 5 and particularly preferably 1 to 3.75 wt. %.

Suitable diol and/or polyol components b) are compounds having at least two isocyanate-reactive hydrogen atoms and an average molecular weight of 62 to 18,000, preferably 62 to 4000 g/mol. Examples of suitable structural components are polyethers, polyesters, polycarbonates, polylactones and polyamides. Preferred polyols b) have 2 to 4, particularly preferably 2 to 3 hydroxyl groups. Mixtures of various compounds of this type are also suitable.

Possible examples of polyester polyols are in particular linear polyester diols or weakly branched polyester polyols, such as can be produced by known means from aliphatic, cycloaliphatic or aromatic dicarboxylic or polycarboxylic acids, such as for example succinic, methyl succinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic, cyclohexanedicarboxylic, maleic, fumaric, malonic or trimellitic acid and acid anhydrides, such as o-phthalic, trimellitic or succinic anhydride or mixtures thereof with polyhydric alcohols, such as for example ethanediol, di-, tri-, tetraethylene glycol, 1,2-propanediol, di-, tri-, tetrapropylene glycol, 1,3-propanediol, butanediol-1,4, butanediol-1,3, butanediol-2,3, pentanediol-1,5, hexanediol-1,6, 2,2-dimethyl-1,3-propanediol, 1,4-dihydroxycyclohexane, 1,4-dimethylol cyclohexane, octanediol-1,8, decanediol-1,10, dodecanediol-1,12 or mixtures thereof, optionally with the incorporation of higher-functional polyols, such as trimethylolpropane, glycerol or pentaerythritol. Cycloaliphatic and/or aromatic di- and polyhydroxyl compounds are also suitable of course as polyhydric alcohols for the production of the polyester polyols. In place of the free polycarboxylic acid, the corresponding polycarboxylic anhydrides or corresponding polycarboxylic acid esters of low alcohols or mixtures thereof can also be used to produce the polyesters.

The polyester polyols can of course also be homopolymers or copolymers of lactones, which are preferably obtained by the addition of lactones or mixtures of lactones, such as butyrolactone, e-caprolactone and/or methyl-ε-caprolactone, to the suitable di- and/or higher-functional starter molecules, such as for example the low-molecular-weight, polyhydric alcohols mentioned above as structural components for polyester polyols. The corresponding polymers of ε-caprolactone are preferred.

Largely linear polyester polyols containing as structural components adipic acid and butanediol-1,4 and/or hexanediol-1,6 and/or 2,2-dimethyl-1,3-propanediol are particularly preferred.

Likewise preferred are polyester polyols containing as structural components isophthalic acid and/or terephthalic acid, and neopentyl glycol, ethylene glycol, butanediol and/or hexanediol.

Polycarbonates having hydroxyl groups are also suitable as polyhydroxyl components, for example those which can be produced by reacting diols such as 1,4-butanediol and/or 1,6-hexanediol with diaryl carbonates, such as for example diphenyl carbonate, dialkyl carbonates, such as for example dimethyl carbonate, or phosgene. The hydrolysis resistance of the polyurethane or polyurethane-urea dispersion adhesives can be improved by the at least partial use of polycarbonates having hydroxyl groups.

Polycarbonates produced by reacting 1,6-hexanediol with dimethyl carbonate are preferred.

Suitable as polyether polyols are for example the polyaddition products of styrene oxides, ethylene oxide, propylene oxide, tetrahydrofuran, butylene oxide, epichlorohydrin, and the co-addition and graft products thereof, as well as the polyether polyols obtained by condensation of polyhydric alcohols or mixtures thereof and by alkoxylation of polyhydric alcohols, amines and amino alcohols. Polyether polyols suitable as structural components A) are the homopolymers, copolymers and graft polymers of propylene oxide and ethylene oxide, which can be obtained by adding the cited epoxides to low-molecular-weight diols or triols such as are mentioned above as structural components for polyester polyols or to higher-functional low-molecular-weight polyols, such as for example pentaerythritol or sugar, or to water.

Particularly preferred di- or higher-functional polyols b) are polyester polyols, polylactones and polycarbonates.

Likewise suitable components b) are low-molecular-weight diols, triols and/or tetraols, such as for example ethanediol, di-, tri-, tetraethylene glycol, 1,2-propanediol, di-, tri-, tetrapropylene glycol, 1,3-propanediol, butanediol-1,4, butanediol-1,3, butanediol-2,3, pentanediol-1,5, hexanediol-1,6, 2,2-dimethyl-1,3-propanediol, 1,4-dihydroxycyclohexane, 1,4-dimethylol cyclohexane, octanediol-1,8, decanediol-1,10, dodecanediol-1,12, neopentyl glycol, 1,4-cyclohexanediol, 1,4-cyclohexane dimethanol, 1,4-, 1,3-, 1,2-dihydroxybenzene or 2,2-bis-(4-hydroxyphenyl)propane (bisphenol A), TCD diol, trimethylolpropane, glycerol, pentaerythritol, dipentaerythritol or mixtures thereof, optionally with incorporation of other uncited diols or triols.

Reaction products of the cited polyols, in particular the low-molecular-weight polyols, with ethylene and/or propylene oxide can also be used as polyols.

The low-molecular-weight components b) have a molecular weight of 62 to 400 g/mol and are preferably used in combination with the polyester polyols, polylactones, polyethers and/or polycarbonates described above.

Polyol component b) is contained in the polyurethane according to the invention in quantities of 20 to 95, preferably 30 to 90 and particularly preferably 65 to 88 wt. %.

Any organic compounds having at least two free isocyanate groups per molecule are suitable as component c). Diisocyanates Y(NCO)₂ are preferably used, wherein Y stands for a divalent aliphatic hydrocarbon radical having 4 to 12 carbon atoms, a divalent cycloaliphatic hydrocarbon radical having 6 to 15 carbon atoms, a divalent aromatic hydrocarbon radical having 6 to 15 carbon atoms or a divalent araliphatic hydrocarbon radical having 7 to 15 carbon atoms. Examples of such diisocyanates which are preferably used are tetramethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethyl cyclohexane, 4,4′-diisocyanatodicyclohexylmethane, 4,4′-diisocyanatodicyclohexylpropane-(2,2), 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate and mixtures consisting of these compounds.

It is of course also possible to incorporate small amounts of higher-functional polyisocyanates known per se in polyurethane chemistry or modified polyisocyanates known per se and containing for example carbodiimide groups, allophanate groups, isocyanurate groups, urethane groups and/or biuret groups.

In addition to these simple diisocyanates, polyisocyanates containing heteroatoms in the radical linking the isocyanate groups and/or having a functionality of more than 2 isocyanate groups per molecule are also suitable. The first group are for example polyisocyanates produced by modification of simple aliphatic, cycloaliphatic, araliphatic and/or aromatic diisocyanates and synthesised from at least two diisocyanates, having a uretdione, isocyanurate, urethane, allophanate, biuret, carbodiimide, iminooxadiazine dione and/or oxadiazine trione structure. 4-Isocyanatomethyl-1,8-octanediisocyanate (nonanetriisocyanate) for example can be cited as an example of a non-modified polyisocyanate having more than 2 isocyanate groups per molecule.

Preferred diisocyanates c) are aliphatic and araliphatic diisocyanates such as hexamethylene diisocyanate, 1,4-diisocyanatocyclohexane, 1-isocyanato-3,3,5-trimethyl-5-isocyanatomethyl cyclohexane, 4,4′-diisocyanatodicyclohexylmethane, 4,4′-diisocyanatodicyclohexylpropane-(2,2), and mixtures consisting of these compounds, which can optionally contain small amounts of 2,4-diisocyanatotoluene and/or 2,6-diisocyanatotoluene.

Most particularly preferred components c) are mixtures of hexamethylene diisocyanate and 1-isocyanato-3,3,5-trimethyl-5-isocyanatomethyl cyclohexane, and mixtures of 1-isocyanato-3,3,5-trimethyl-5-isocyanatomethyl cyclohexane and/or 4,4′-diisocyanatodicyclohexyl methane and/or 2,4-diisocyanatotoluene and/or 2,6-diisocyanatotoluene.

Component c) is contained in the polyurethane according to the invention in quantities of 5 to 60, preferably 6 to 45 and particularly preferably in quantities of 7 to 25 wt. %.

Suitable as component d) are aminocarboxylic acids and/or hydroxycarboxylic acids which each contain only one isocyanate-reactive amino group or hydroxyl group and which thus in the production of the polyurethanes according to the invention by reaction with the isocyanate component lead to terminal carboxyl groups. Linear aliphatic, branched aliphatic, aliphatic-aromatic and aromatic aminocarboxylic acids or hydroxycarboxylic acids are suitable. Aminocarboxylic acids having a primary or secondary amino group can be cited by way of example as a suitable component d), such as alanine, 6-aminohexanoic acid, aminoundecanoic acid, 8-aminooctanoic acid, 5-aminopentanoic acid, 4-aminobutyric acid, aminobenzoic acid, 5-aminonaphthalene-1-sulfonic acid, 4-aminonaphthalene-l-sulfonic acid, 2-aminonaphthalene-1-sulfonic acid, 5-aminonaphthalene-2-sulfonic acid, 8-aminonaphthalene-1-sulfonic acid, 3-aminonaphthalene-2-sulfonic acid, 4-aminomethylcyclohexane carboxylic acid, 2-aminohexanoic acid, 4-aminocyclohexane carboxylic acid, 12-aminododecanoic acid, 9-aminononacarboxylic acid. Likewise suitable are hydroxycarboxylic acids having a hydroxyl group, such as for example hydroxypivalic acid, hydroxyacetic acid and 2-hydroxypropanoic acid.

Exclusively aminocarboxylic acids are preferably used as component d), and particularly preferably aminoalkyl carboxylic acids such as 6-aminohexanoic acid, which are contained in the polymer in the form incorporated via the amino group.

Component d) is contained in the polyurethane according to the invention in quantities of 0.25 to 10, preferably 0.5 to 5 and particularly preferably in quantities of 0.75 to 3.5 wt. %.

The number of terminal carboxyl groups available for crosslinking reactions can be defined by means of the acid value induced by these carboxyl groups. The polyurethane dispersions according to the invention have acid values induced by component d) of 2 to 45 mg KOH/g substance, preferably 3 to 18 mg KOH/g substance and particularly preferably 3 to 12 mg KOH/g substance. The acid values relate here to 100% solids content of the polyurethane contained in the polyurethane dispersion according to the invention.

Suitable components e) are mono-, di-, trifunctional amines and/or mono-, di-, trifunctional hydroxyamines, such as for example aliphatic and/or alicyclic primary and/or secondary monoamines such as ethylamine, diethylamine, isomeric propylamines and butylamines, higher linear-aliphatic monoamines and cycloaliphatic monoamines such as cyclohexylamine. Further examples are amino alcohols, i.e. compounds containing amino and hydroxyl groups in one molecule, such as for example ethanolamine, N-methyl ethanolamine, diethanolamine, diisopropanolamine, 1,3-diamino-2-propanol, N-(2-hydroxyethyl)ethylenediamine, N,N-bis(2-hydroxyethyl)ethylenediamine and 2-propanolamine. Further examples are diamines and triamines such as for example 1,2-ethanediamine, 1,6-hexamethylenediamine, 1-amino-3,3,5-trimethyl-5-aminomethyl cyclohexane(isophoronediamine), piperazine, 1,4-diaminocyclohexane, bis-(4-aminocyclohexyl)methane and diethylenetriamine. Adipic acid dihydrazide, hydrazine and hydrazine hydrate are also suitable. Naturally mixtures of several of the cited compounds e), optionally also together with uncited compounds e), can also be used.

Preferred components e) are 1,2-ethanediamine, 1-amino-3,3,5-trimethyl-5-aminomethyl cyclohexane, diethylenetriamine, diethanolamine, ethanolamine, N-(2-hydroxyethyl)ethylenediamine and N,N-bis(2-hydroxyethyl)ethylenediamine.

Components e) preferably serve as chain extenders to establish higher molecular weights or as monofunctional compounds to limit molecular weights and/or optionally additionally to incorporate further reactive groups, such as for example free hydroxyl groups, as further crosslink points.

Component e) is contained in the polyurethane according to the invention in quantities of 0 to 10, preferably 0 to 5 and particularly preferably in quantities of 0.25 to 4 wt. %.

Components f) which can optionally be incorporated can for example be aliphatic, cycloaliphatic or aromatic monoalcohols having 2 to 22 C atoms, such as ethanol, butanol, hexanol, cyclohexanol, isobutanol, benzyl alcohol, stearyl alcohol, 2-ethyl ethanol, cyclohexanol; hydrophilising mono- or difunctional polyethers based on ethylene oxide polymers or ethylene oxide/propylene oxide copolymers started on alcohols or amines, such as for example polyether LB 25 (Bayer Material Science AG; Germany) or MPEG 750: methoxypolyethylene glycol, molecular weight 750 g/mol (e.g. Pluriol® 750, BASF AG, Germany); blocking agents conventionally used for isocyanate groups which can be eliminated again at elevated temperature, such as for example butanone oxime, dimethylpyrazole, caprolactam, malonic ester, triazole, dimethyltriazole, tert-butyl benzylamine, cyclopentanone carboxyethyl ester; unsaturated compounds containing groups accessible for polymerisation reactions, such as for example hydroxyethyl acrylate, hydroxyethyl methacrylate, hydroxybutyl acrylate, hydroxybutyl methacrylate, hydroxypropyl acrylate, hydroxypropyl methacrylate, pentaerythritol trisacylate, hydroxy-functional reaction products of monoepoxides, bisepoxides and/or polyepoxides with acrylic acid or methacrylic acid.

Components f) can be contained in the polyurethane according to the invention in quantities of 0 to 20, preferably 0 to 10 wt. %.

The incorporation of component f) can lead for example to polyurethane dispersions according to the invention which contain further reactive groups in addition to the reactive carboxyl groups, making it possible for example to use different crosslinking mechanisms (dual core) in order to achieve special properties, such as for example a two-stage, optionally delayed cure or a particularly high crosslink density.

Crosslinking preferably takes place predominantly or exclusively via the incorporated terminal carboxyl groups, such that there is no need for component f).

The polyurethane dispersions according to the invention have solids contents of 15 to 70, preferably 20 to 60 wt. %. The pH is in the range from 4 to 11, preferably 5 to 10. The average particle size is conventionally between 20 and 750 nm, preferably between 30 and 450 nm.

The present invention also provides a process for the production of the aqueous polyurethane or polyurethane-urea dispersions according to the invention, characterised in that components a), b), c) and optionally f) are reacted in a single-stage or multistage reaction to form an isocyanate-functional prepolymer, which is then reacted with component d) and optionally e) in a one- or two-stage reaction and is then dispersed in or with water, wherein optionally incorporated solvent can be partially or completely removed by distillation during or after dispersion.

Production of the aqueous polyurethane or polyurethane-urea dispersions according to the invention can be performed in one or more stages in the homogeneous phase or in the case of a multistage reaction in part in the dispersed phase. The completely or partially performed polyaddition is followed by a dispersion, emulsification or dissolution step. This is optionally followed by a further polyaddition or modification in the dispersed phase. All known processes from the prior art, such as emulsifier shear force, acetone, prepolymer mixing, melt emulsification, ketimine and solids spontaneous dispersion processes or derivatives thereof, can be used for the production, A summary of these methods can be found in Methoden der organischen Chemie (Houben-Weyl, Erweiterungs- and Folgebande zur 4. Auflage, Volume E20, H. Bartl and J. Falbe, Stuttgart, New York, Thieme 1987, p. 1671-1682). The melt emulsification, prepolymer mixing and acetone processes are preferred. The acetone process is particularly preferred.

In principle it is possible to weigh in all hydroxy-functional components, followed by all isocyanate-functional components, and then to react them to form an isocyanate-functional polyurethane, which is then reacted with the amino-functional components. A reversed production sequence, weighing in the isocyanate component, adding the hydroxy-functional components, reacting them to form the polyurethane and then reacting with the amino-functional components to form the end product, is also possible.

All or part of the hydroxy-functional components b), optionally f) and optionally a) are conventionally introduced into the reactor, optionally diluted with a water-miscible solvent which is inert to isocyanate groups and then homogenised to produce a polyurethane prepolymer. Component c) is then added at room temperature to 120° C. and an isocyanate-functional polyurethane is produced. This reaction can take place in a single stage or in multiple stages. A multistage reaction can take place for example by introducing a component b) and after reaction with the isocyanate-functional component c) adding a second component a), which can then react with part of the isocyanate groups still present.

Suitable solvents are for example acetone, methyl isobutyl ketone, butanone, tetrahydrofuran, dioxane, acetonitrile, dipropylene glycol dimethyl ether and 1-methyl-2-pyrrolidone, which can be added not only at the start of production but optionally in part also later. Acetone and butanone are preferred. It is possible to perform the reaction under normal pressure or elevated pressure.

The amounts of the hydroxy-functional and optionally amino-functional components used to produce the prepolymer are calculated such that an isocyanate value of 1.05 to 2.5, preferably 1.15 to 1.85, results.

The further reaction, known as the chain extension, of the isocyanate-functional prepolymer with other hydroxy-functional and/or amino-functional, preferably only amino-functional, components a), d), e) and optionally f) takes place in such a way that a degree of conversion of 25 to 150, preferably 40 to 85% of hydroxyl and/or amino groups relative to 100% isocyanate groups is selected.

With degrees of conversion above 100%, which are possible but less preferable, it is appropriate firstly to convert all monofunctional components for the purposes of the isocyanate addition reaction with the prepolymers and then to add the difunctional or higher-functional chain extension components in order to obtain as complete an incorporation of all chain extension molecules as possible.

The degree of conversion is conventionally monitored by tracking the NCO content of the reaction mixture. Both spectroscopic measurements, for example infrared or near-infrared spectra, determination of the refractive index, and chemical analyses, such as titrations of samples, can be undertaken to this end.

Conventional catalysts such as are known to the person skilled in the art for accelerating the NCO—OH reaction can be used to accelerate the isocyanate addition reaction. Examples are triethylamine, 1,4-diazabicyclo-[2,2,2]-octane, dibutyl tin oxide, tin dioctate or dibutyl tin dilaurate, tin-bis-(2-ethylhexanoate) or other organometallic compounds.

The chain extension of the isocyanate-functional prepolymer with component d) and optionally e) can be performed before dispersion, during dispersion or after dispersion. The chain extension preferably takes place before dispersion. If component a) is used as a chain extension component, a chain extension with this component before the dispersion step is obligatory.

The chain extension is conventionally performed at temperatures of 10 to 100° C., preferably 25 to 60° C.

Within the meaning of the present invention the term chain extension also includes the reactions of optionally monofunctional components d) or e), which because of their monofunctionality act as chain terminators and thus lead not to an increase but to a restriction of the molecular weight.

The chain extension components can be diluted with organic solvents and/or with water for addition to the reaction mixture. The components can be added in any order or simultaneously by adding a mixture.

For the purposes of producing the polyurethane dispersion the prepolymer is either introduced into the dispersing water, optionally with intensive shearing, such as for example vigorous stirring, or conversely the dispersing water is stirred into the prepolymer. Chain extension can then take place if it has not already occurred in the homogeneous phase.

The organic solvent optionally used, for example acetone, is distilled off during and/or after dispersion.

A preferred production process is described below:

Component b), optionally component a) and optionally component f) and optionally solvent are weighed out and heated to 20 to 100° C. Component c) is added as quickly as possible whilst stirring. Taking advantage of the exothermic reaction the reaction mixture is stirred at 40 to 150° C. until the theoretical isocyanate content has been reached or almost reached. Catalyst can optionally be added. The mixture is then diluted to solids contents of 25 to 95, preferably 40 to 80 wt. %, by addition of solvent, and then chain extension is performed at 30 to 120° C. by adding component d) diluted with water and/or solvent, optionally together with component a) and/or component e) and/or component f). After a reaction time of 2 to 60 minutes dispersion is performed by adding distilled water or by transferring the mixture into distilled water and all or part of the solvent used is distilled off during or after the dispersion step.

The dispersions according to the invention can be used alone or with binders, auxiliary substances and additives known in coating and adhesives technology, in particular emulsifiers and light stabilisers such as UV absorbers and sterically hindered amines (HALS), also antioxidants, fillers and auxiliary agents, for example antisettling agents, defoaming and/or wetting agents, flow control agents, reactive thinners, plasticisers, neutralising agents, catalysts, auxiliary solvents and/or thickeners, and additives such as for example pigments, dyes or matting agents. Tackifiers can also be added.

The additives can be added to the product according to the invention immediately before processing. It is also possible, however, to add at least part of the additives before or during dispersion of the binder.

The selection and amounts to be used of these substances, which can be added to the individual components and/or to the complete mixture, are known in principle to the person skilled in the art and can be determined by means of simple preliminary experiments tailored to the specific application without undue expense.

The dispersions can also be mixed together with other aqueous or solvent-containing oligomers or polymers and used together. Polyvinyl ester, polyvinyl ether, polyvinyl alcohol, polyethylene, polystyrene, polybutadiene, polyvinyl chloride, polyurethane, polyurethane-polyurea, polyurethane-polyacrylate, polyester, polyacrylate and/or copolymer dispersions or emulsions or aqueous or organic solvents, for example, are suitable in principle. The compatibility of such mixtures must be tested in each case by means of simple preliminary experiments.

Combinations with binders of the type cited by way of example, containing functional groups such as for example carboxyl groups, hydroxyl groups and/or blocked isocyanate groups, are also possible.

The present invention likewise provides binder combinations for coating, adhesive and/or sealant applications, containing i) the polyurethane or polyurethane-urea dispersions according to the invention.

In a preferred embodiment these binder combinations further contain ii) crosslinkers containing carboxyl-reactive groups, such as for example carbodiimides, aziridines, epoxides having at least two reactive groups.

The binder combinations according to the invention preferably contain 50 to 99.5, preferably 75 to 99, particularly preferably 88 to 99 wt. % of component i) and 0.5 to 50, preferably 1 to 25, particularly preferably 1 to 12 wt. % of component ii).

The binder combinations according to the invention preferably contain in component ii) crosslinkers having carbodiimide groups.

Carbodiimide crosslinkers are particularly preferred which are dispersed, emulsified, dissolved in water or are dispersible, emulsifiable and/or soluble in water.

Crosslinkers containing carbodiimide structures are preferred which contain on average 3 to 20, particularly preferably on average 4 to 8 carbodiimide structural units per molecule.

Such carbodiimide crosslinkers can be obtained for example by carbodiimidisation of diisocyanates such as for example tetramethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethyl cyclohexane, 4,4′-diisocyanatodicyclohexylmethane, 4,4′-diisocyanatodicyclohexylpropane-(2,2), 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, optionally with incorporation of monofunctional isocyanates such as for example stearyl isocyanate, phenyl isocyanate, butyl isocyanate, hexyl isocyanate or/and higher-functional isocyanates such as trimers, uretdiones, allophanates, biurets of the diisocyanates cited by way of example, with subsequent, simultaneous or preliminary reaction with hydrophilising components, for example mono- or difunctional polyethers based on ethylene oxide polymers or ethylene oxide/propylene oxide copolymers started on alcohols or amines.

Preferred carbodiimides ii) are obtained by carbodiimidisation of 1-isocyanato-3,3,5-trimethyl-5-isocyanatomethyl cyclohexane and/or 4,4′-diisocyanatodicyclohexylmethane.

The use of mixed carbodiimides, containing for example carbodiimides based on different isocyanates, is likewise possible.

Suitable carbodiimides ii) are for example Carbodilite® SV-02, Carbodilite® V-02-L2 and Carbodilite® E-02 (all from Nisshinbo Industries, Tokyo, Japan). Carbodilite® V-02-L2 is a preferred carbodiimide.

Carbodilite® V-02-L2 is a non-ionically hydrophilised, cycloaliphatic carbodiimide, 40 wt. % in water, having a carbodiimide equivalent weight of approximately 385.

Suitable carbodiimides ii) are likewise aqueous carbodiimide dispersions or carbodiimide emulsions or carbodiimide solutions and/or water-dispersible carbodiimides, containing reaction products of
A) at least one carbodiimide having on average 3 to 20, preferably 4 to 8 carbodiimide structural units based on Desmodur® W, Desmodur® I, Desmodur® H and/or Desmodur® T (all Bayer MaterialScience, Germany) and
B) hydrophilic components such as for example at least one hydroxy-functional polyether based on ethylene oxide or based on ethylene and propylene oxide, such as for example methoxypolyethylene glycols, ethoxypolyethylene glycols, butoxypolyethylene glycols having molecular weights of 350 to 3000 g/mol, such as Carbowax® MPEG 750, MPEG 550, MPEG 350 (DOW Chemical Company, USA), polyether LB 25 (Bayer MaterialScience, Germany) and/or corresponding amino-functional polyethers and/or ionic hydrophilising substances such as salts of aminocarboxylic acids, hydroxycarboxylic acids or aminosulfonic acids, such as for example dimethylol propionic acid, dimethylol butyric acid, hydroxypivalic acid, aminoethanesulfonic acid,
C) optionally other hydroxy- and/or amino-functional and/or other isocyanate-reactive compounds such as for example monoalcohols such as butyl glycol, butyl diglycol, ethoxydiglycol, methoxypropanol, methoxyglycol, methanol, benzyl alcohol, fatty alcohols, 2-ethyl hexanol, stearyl alcohol, oleyl alcohol, ethanol, butanol, isopropanol, hexanol, cyclohexanol, octanol, pentanol and/or monoamines, oximes, lactams such as diethylamine, diisopropylamine, triazole, dimethyltriazole, dimethylpyrazole, morpholine, butanone oxime, caprolactam, tert-butyl benzylamine and/or malonic acid dialkyl esters, acetoacetic esters, cyclopentanone carboxyalkyl esters and/or diols, diamines, amino alcohols, triols such as for example trimethylolpropane, glycerol, neopentyl glycol, butanediol, ethylene glycol, cyclohexanediol, cyclohexane dimethanol, propylene glycol, diethylene glycol, dipropylene glycol, triethylene glycol, tripropylene glycol, ethanolamine, diethanolamine, isopropanolamine, diisopropanolamine, triethanolamine, hydroxyethyl ethylenediamine, ethylenediamine, isophoronediamine, hexamethylenediamine, hydrazine.

Components A), B) and C) can be reacted in any order, optionally also in the presence of solvents.

Carbodiimides ii) preferably contain reaction products consisting of

50 to 97 wt. % of component A),

3 to 40 wt. % of component B) and

0 to 25 wt. % of component C).

The carbodiimides ii) particularly preferably contain reaction products consisting of

60 to 90 wt. % of component A),

5 to 27 wt. % of component B) and

0.5 to 15 wt. % of component C).

The carbodiimides can be produced by known processes. Suitable as catalysts are for example heterocyclic compounds containing bound phosphorus, metal carbonyls, phospholines, phospholenes and phospholidines and oxides and sulfides thereof.

Preferably a carbodiimide is first reacted by heating at least one at least difunctional isocyanate in the presence of a suitable catalyst, such as for example phospholine oxide, at 100 to 250° C. with carbon dioxide elimination until the desired degree of conversion is obtained, and then reacting this carbodiimide in a further reaction step with component B) and optionally simultaneously or subsequently with component C) and then optionally dispersing, emulsifying or dissolving it.

Preferred binder combinations contain

75 to 99 wt. % of dispersion according to the invention, component i), and

1 to 25 wt. % of Carbodilite® V-02-L2 II, component ii).

Particularly preferred binder combinations contain

88 to 99 wt. % of dispersion according to the invention, component i), and

1 to 12 wt. % of Carbodilite® V-02-L2 II, component ii).

Binder combinations according to the invention in coating applications are suitable for example for the coating or lacquering of any substrates, such as for example metals and alloys of all types, wood, wood-based materials, chipboard, MDF boards, ceramics, stone, concrete, bitumen, hard fibres, glass, glass fibres, carbon fibres, carbon nanotubes, porcelain, plastics, leather, textiles and/or textile fibres of a wide variety of types.

The invention likewise provides substrates coated or lacquered with the binder combinations according to the invention.

Corresponding binders or binder combinations in adhesive applications are suitable for bonding any substrates such as for example paper, cardboard, wood, textiles, metal, alloys, fabrics, fibres, synthetic leather, leather or mineral materials. They are likewise suitable for bonding rubber materials such as for example natural and synthetic rubbers, various plastics such as polyurethanes, polyvinyl acetate, polyvinyl chloride, in particular plasticiser-containing polyvinyl chloride. The adhesives are likewise suitable for bonding thermoplastics such as for example ABS (acrylic-butadiene-styrene), PC (polycarbonate) and mixtures thereof, and polyolefinic plastics, optionally after suitable pretreatment.

The adhesives are likewise suitable for use for bonding soles made from these materials, in particular based on polyvinyl chloride, in particular plasticiser-containing polyvinyl chloride, or based on polyethyl vinyl acetate or polyurethane elastomer foam, with shoe uppers made from leather or synthetic leather. The adhesives according to the invention are also particularly suitable for bonding films based on polyvinyl chloride or plasticiser-containing polyvinyl chloride with wood.

The present application likewise provides adhesive composites containing substrates bonded with the polyurethane or polyurethane-urea dispersions according to the invention.

The coating compounds or adhesives according to the invention are processed by the known methods of coating technology or adhesives technology in terms of the use and processing of aqueous dispersions or aqueous emulsions or aqueous solutions.

### EXAMPLES

Materials Used
Polyester I: 1,4-Butanediol polyadipate diol, OH value=50
Polyester II: Polyester diol consisting of 1,6-hexanediol, neopentyl glycol and adipic acid, OH value=66
Polyester III: 1,4-Butanediol polyadipate diol, OH value=120
Polyester IV: 1,6-Hexanediol polyphthalate diol, OH value=56
Desmodur® H: Hexamethylene diisocyanate-1,6 (Bayer MaterialScience AG, Leverkusen, Germany)
Desmodur® I: Isophorone diisocyanate (Bayer MaterialScience AG, Leverkusen, Germany)
Polyether LB 25: Ethylene oxide polyether started on butanol, with an average molecular weight of 2250 g/mol
Emulsifier FD®: Fatty alcohol polyethylene/propylene glycol)ether (Lanxess AG, Leverkusen, Germany)
Carbodiimide A): Carbodilite® V-02-L2 (Nisshinbo Industries Inc, Japan)
Carbodiimide B): Aqueous carbodiimide dispersion produced by reacting 4.5 equivalents of a carbodiimide having on average approximately 4 carbodiimide structural units and based on Desmodur® W (Bayer MaterialScience, Germany) with 1 equivalent of Carbowax® MPEG 750 (DOW Chemical Company, USA) and 3.5 equivalents of butyl glycol, 40% dispersed in water.

### Example 1

759 g of polyester I are dehydrated at 110° C. and under 15 mbar for 1 hour and then 3.4 g of trimethylolpropane are added and the mixture is cooled whilst stirring. 56.7 g of Desmodur® H are added at 60° C., followed by 50.0 g of Desmodur® I. The mixture is stirred at 80 to 90° C. until an isocyanate content of 1.8% is achieved. The reaction mixture is dissolved in 1300 g of acetone and cooled to 50° C. A solution of 14.95 g of sodium salt of N-(2-aminoethyl)-2-aminoethanesulfonic acid and 12.8 g of 6-aminohexanoic acid in 75 g of water is added to the homogeneous solution whilst stirring vigorously. After 30 minutes the mixture is dispersed by adding 1015 g of water. After separating off the acetone by distillation 10.1 g of emulsifier FD® are added. A solvent-free, aqueous polyurethane-polyurea dispersion is obtained with a solids content of 47 wt. % and an average particle size in the dispersed phase, determined by laser correlation, of 350 nm. The pH is 6.0. The amount of terminal carboxyl groups available for crosslinking, defined by the calculated acid value, =6.0 mg KOH/g substance (relative to 100% solids content of the dispersion).

### Example 2

633 g of polyester I and 96 g of polyester II are dehydrated at 110° C. and under 15 mbar for 1 hour and then 3.4 g of trimethylolpropane are added and the mixture is cooled whilst stirring. 56.7 g of Desmodur® H are added at 60° C., followed by 50.0 g of Desmodur® I. The mixture is stirred at 80 to 90° C. until an isocyanate content of 1.5% is achieved. The reaction mixture is dissolved in 1250 g of acetone and cooled to 50° C. A solution of 17.1 g of sodium salt of N-(2-aminoethyl)-2-aminoethanesulfonic acid and 12.8 g of 6-aminohexanoic acid in 75 g of water is added to the homogeneous solution whilst stirring vigorously. After 30 minutes the mixture is dispersed by adding 1130 g of water. After separating off the acetone by distillation 10.1 g of emulsifier FD® are added. A solvent-free, aqueous polyurethane-polyurea dispersion is obtained with a solids content of 44 wt. % and an average particle size in the dispersed phase, determined by laser correlation, of 226 nm. The pH is 5.9. The amount of terminal carboxyl groups available for crosslinking, defined by the calculated acid value, =6.2 mg KOH/g substance (relative to 100% solids content of the dispersion).

### Example 3

709 g of polyester I are dehydrated at 110° C. and under 15 mbar for 1 hour and then 3.1 g of trimethylolpropane are added and the mixture is cooled whilst stirring. 52.9 g of Desmodur® H are added at 60° C., followed by 46.6 g of Desmodur® I. The mixture is stirred at 80 to 90° C. until an isocyanate content of 1.7% is achieved. The reaction mixture is dissolved in 1200 g of acetone and cooled to 50° C. A solution of 14.6 g of sodium salt of N-(2-aminoethyl)-2-aminoethanesulfonic acid and 10.4 g of 6-aminohexanoic acid in 70 g of water is added to the homogeneous solution whilst stirring vigorously. After 30 minutes the mixture is dispersed by adding 975 g of water. After separating off the acetone by distillation 9.5 g of emulsifier FD® are added. A solvent-free, aqueous polyurethane-polyurea dispersion is obtained with a solids content of 49 wt. % and an average particle size in the dispersed phase, determined by laser correlation, of 230 nm. The pH is 5.9. The amount of terminal carboxyl groups available for crosslinking, defined by the calculated acid value, =6.5 mg KOH/g substance (relative to 100% solids content of the dispersion).

### Example 4

506 g of polyester I and 162 g of polyester III are dehydrated at 110° C. and under 15 mbar for 1 hour and then 4 g of trimethylolpropane are added and the mixture is cooled whilst stirring. 68 g of Desmodur® H are added at 60° C., followed by 51.9 g of Desmodur® I. The mixture is stirred at 80 to 90° C. until an isocyanate content of 1.4% is achieved. The reaction mixture is dissolved in 1180 g of acetone and cooled to 50° C. A solution of 16.2 g of sodium salt of N-(2-aminoethyl)-2-aminoethanesulfonic acid and 14.1 g of 6-aminohexanoic acid in 90 g of water is added to the homogeneous solution whilst stirring vigorously. After 30 minutes the mixture is dispersed by adding 1000 g of water. After separating off the acetone by distillation 9.2 g of emulsifier FD® are added. A solvent-free, aqueous polyurethane-polyurea dispersion is obtained with a solids content of 47 wt. % and an average particle size in the dispersed phase, determined by laser correlation, of 244 nm. The pH is 5.9. The amount of terminal carboxyl groups available for crosslinking, defined by the calculated acid value, =7.3 mg KOH/g substance (relative to 100% solids content of the dispersion).

### Example 5

810 g of polyester I are dehydrated at 110° C. and under 15 mbar for 1 hour and then 8.1 g of 1,4-butanediol are added and the mixture is cooled whilst stirring. 64.3 g of Desmodur® H are added at 60° C., followed by 59.9 g of Desmodur® I. The mixture is stirred at 80 to 90° C. until an isocyanate content of 1.6% is achieved. The reaction mixture is dissolved in 1400 g of acetone and cooled to 50° C. A solution of 16.0 g of sodium salt of N-(2-aminoethyl)-2-aminoethanesulfonic acid and 12.5 g of 6-aminohexanoic acid in 90 g of water is added to the homogeneous solution whilst stirring vigorously. After 30 minutes the mixture is dispersed by adding 900 g of water. After separating off the acetone by distillation 12.2 g of emulsifier FD® are added. A solvent-free, aqueous polyurethane-polyurea dispersion is obtained with a solids content of 47 wt. % and an average particle size in the dispersed phase, determined by laser correlation, of 148 nm. The pH is 6.2. The amount of terminal carboxyl groups available for crosslinking, defined by the calculated acid value, =7.1 mg KOH/g substance (relative to 100% solids content of the dispersion).

### Example 6

630 g of polyester IV are dehydrated at 110° C. and under 15 mbar for 1 hour and then 5.3 g of 1.6-hexanediol are added and the mixture is cooled whilst stirring. 94.5 g of Desmodur® H are added at 60° C. The mixture is stirred at 80 to 90° C. until an isocyanate content of 1.5% is achieved. The reaction mixture is dissolved in 1080 g of acetone and cooled to 50° C. A solution of 22.1 g of sodium salt of N-(2-aminoethyl)-2-aminoethanesulfonic acid and 14.4 g of 6-aminohexanoic acid in 90 g of water is added to the homogeneous solution whilst stirring vigorously. After 30 minutes the mixture is dispersed by adding 900 g of water. After separating off the acetone by distillation a solvent-free, aqueous polyurethane-polyurea dispersion is obtained with a solids content of 47 wt. % and an average particle size in the dispersed phase, determined by laser correlation, of 254 nm. The pH is 6.2. The amount of terminal carboxyl groups available for crosslinking, defined by the calculated acid value, =7.4 mg KOH/g substance (relative to 100% solids content of the dispersion).

### Example 7

803 g of polyester I are dehydrated at 110° C. and under 15 mbar for 1 hour and then 3 g of trimethylolpropane are added. 61.7 g of Desmodur® H and 56.6 g of Desmodur® I are added at 60° C. The mixture is stirred at 80 to 90° C. until an isocyanate content of 2.1% is achieved. The reaction mixture is dissolved in 1400 g of acetone and cooled to 50° C. A solution of 22.6 g of sodium salt of N-(2-aminoethyl)-2-aminoethanesulfonic acid and 19.2 g of 6-aminohexanoic acid in 85 g of water is added to the homogeneous solution whilst stirring vigorously. After 30 minutes the mixture is dispersed by adding 1000 g of water. After separating off the acetone by distillation a solvent-free, aqueous polyurethane-polyurea dispersion is obtained with a solids content of 52 wt. % and an average particle size in the dispersed phase, determined by laser correlation, of 550 nm. The pH is 5.9. The amount of terminal carboxyl groups available for crosslinking, defined by the calculated acid value, =8.4 mg KOH/g substance (relative to 100% solids content of the dispersion).

### Example 8

765 g of polyester I and 72 g of polyester II are dehydrated at 110° C. and under 15 mbar for 1 hour and then 3.5 g of 1,4-butanediol are added and the mixture is cooled whilst stirring. 65.7 g of Desmodur® H are added at 60° C., followed by 45.3 g of Desmodur® I. The mixture is stirred at 80 to 90° C. until an isocyanate content of 1.3% is achieved. The reaction mixture is dissolved in 1420 g of acetone and cooled to 50° C. A solution of 16 g of sodium salt of N-(2-aminoethyl)-2-aminoethanesulfonic acid and 10 g of 6-aminohexanoic acid in 75 g of water is added to the homogeneous solution whilst stirring vigorously. After 30 minutes the mixture is dispersed by adding 830 g of water. After separating off the acetone by distillation a solvent-free, aqueous polyurethane-polyurea dispersion is obtained with a solids content of 49 wt. % and an average particle size in the dispersed phase, determined by laser correlation, of 226 nm. The pH is 6.2. The amount of terminal carboxyl groups available for crosslinking, defined by the calculated acid value, =4.4 mg KOH/g substance (relative to 100% solids content of the dispersion).

### Example 9

840 g of polyester I are dehydrated at 110° C. and under 15 mbar for 1 hour and then cooled whilst stirring. 56.2 g of Desmodur® H are added at 60° C., followed by 37.5 g of Desmodur® I. The mixture is stirred at 80 to 90° C. until an isocyanate content of 1.3% is achieved. The reaction mixture is dissolved in 1390 g of acetone and cooled to 50° C. A solution of 14 g of sodium salt of N-(2-aminoethyl)-2-aminoethanesulfonic acid and 7.9 g of 6-aminohexanoic acid in 75 g of water is added to the homogeneous solution whilst stirring vigorously. After 30 minutes the mixture is dispersed by adding 850 g of water. After separating off the acetone by distillation a solvent-free, aqueous polyurethane-polyurea dispersion is obtained with a solids content of 47 wt. % and an average particle size in the dispersed phase, determined by laser correlation, of 184 nm. The pH is 6.3. The amount of terminal carboxyl groups available for crosslinking, defined by the calculated acid value, =3.5 mg KOH/g substance (relative to 100% solids content of the dispersion).

Determination of the Application Properties:

Production of Adhesive Dispersions:

100 parts by weight of the dispersions (examples 1 to 9) are weighed out and 5 or 10 parts by weight of carbodiimide A) are added whilst stirring. For comparative purposes some of the dispersions were also tested without carbodiimide.

Determination of the Peel Strengths (Bond Strengths)

The peel strengths are determined with the following composite combinations:

| | | |
|---|---|---|
| Composite A: | Substrate 1: Leather | Substrate 2: Leather |
| Composite B: | Substrate 1: Canvas | Substrate 2: Canvas |
| Composite C: | Substrate 1: PVC (30%*) | Substrate 2: PVC (30%*) |

*Plasticiser content 30%

Production of Specimens and Performance of the Test:

The adhesive dispersions are first applied thinly to 3 cm wide and 25 long substrate strips using a brush and dried for 1 hour in a standard conditioning atmosphere (23° C./50% relative humidity). After drying, the adhesive coatings are heat-activated with a Funck IR heater (shock activator model 2000), the heat activation period being dependent on the substrate used and being 7 s for composite A, 3.5 s for composite B and 10 s for composite C. In all cases the maximum surface temperature of the heat-activated adhesive layers is approx. 90° C.

After heat activation the adhesive-coated sides of the substrates are laid on top of one another and pressed in a hydraulic press under a pressure of 4 bar for 1 minute. The peel strengths of the bonded joints are determined immediately after opening the press and after 3 days' storage in a standard conditioning atmosphere (23° C./50% relative humidity) in a T-peel test at a peeling rate of 100 mm/min using a Franck universal testing machine

Determination of the Heat Resistance

Determination of the Heat Resistance from the Softening Point (=Shear Loading):

Production of Specimens and Test

The softening point values were determined with the following composite combinations:

| | | |
|---|---|---|
| Composite D: | Substrate 1: PVC (30%*) | Substrate 2: PVC (30%*) |
| Composite E: | Substrate 1: Canvas | Substrate 2: Canvas |

*Plasticiser content 30%

Immediately before applying the adhesive the specimens (25 mm×50 mm) are washed with ethyl acetate and dried. The adhesive dispersions are then applied with a brush to the 20 mm×10 mm surfaces to be bonded. The adhesive layer is dried for 60 min at 23° C./50% relative humidity.

The adhesive-coated specimens are heat-activated for 10 seconds with a Funck IR heater (shock activator model 2000). This raises the temperature of the surface of the PVC specimens to approximately 90° C. The bonded joint is produced immediately after heat activation by pressing the activated adhesive layers together in a press under 4 bar for 1 minute. The specimens produced in this way are stored for 1 week in a standard conditioning atmosphere (23° C./50% relative humidity).

After being stored, the specimens are loaded with 4 kg and heated in an oven to 40° C. within 30 min. Then the specimens are heated to 150° C. at a linear heating-up rate of 0.5 K./min. The softening temperature, i.e. the temperature in ° C. at which the bonded joint fails under the 4 kg load, is recorded.

Determination of the Hot Peel Strength After Bonding by Hot Press Moulding (=Heat Resistance)

Production of Specimens and Test

The adhesive dispersions are applied to one side of planed beech boards (dimension 50 mm×140 mm×4 mm) using a grooved doctor knife (100 μm). The surface to be bonded measures 50 mm×110 mm. After a drying period of 60 min at 23° C./50% relative humidity a PVC decorative furniture film (manufactured by Rhenolit) is applied to the dried adhesive layer and pressed for 10 s under 4 bar in a membrane press heated to 103° C. The maximum glueline temperature under these conditions is 90° C. (composite F).

The specimens are stored for 3 days in a standard conditioning atmosphere (23° C./50% relative humidity). The heat resistance is determined in a universal oven with automatic temperature control. To this end the unbonded ends of the beech specimens are fixed to a bracket using wing screws. The protruding end of the PVC strip is loaded vertically downwards at an angle of 180° with a 500 g weight. The starting temperature is 50° C. The temperature is automatically increased by 10° C. once an hour until the PVC strip is completely detached (or torn away) from the beech specimen. The final temperature for this method is 120° C.

The Following Adhesive Formulations are Produced:

| | | Parts by |
|---|---|---|
| Adhesive | 100 parts | weight |
| formulation | by weight | carbodiimide |
| no. | PUD | A) |
| 1a | Example 1 | 5 |
| 1b | Example 1 | 10 |
| 2 | Example 2 | 0 |
| 2a | Example 2 | 5 |
| 2b | Example 2 | 10 |
| 3a | Example 3 | 5 |
| 3b | Example 3 | 10 |
| 4 | Example 4 | 0 |
| 4a | Example 4 | 5 |
| 4b | Example 4 | 10 |
| 5a | Example 5 | 5 |
| 5b | Example 5 | 10 |
| 6 | Example 6 | 0 |
| 6a | Example 6 | 5 |
| 6b | Example 6 | 10 |
| 7 | Example 7 | 0 |
| 7a | Example 7 | 5 |
| 7b | Example 7 | 10 |
| 8 | Example 8 | 0 |
| 8a | Example 8 | 5 |
| 8b | Example 8 | 10 |
| 9 | Example 9 | 0 |
| 9a | Example 9 | 5 |
| 9b | Example 9 | 10 |

| | | |
|---|---|---|
| Composite A: | Substrate 1: Leather | Substrate 2: Leather |
| Composite B: | Substrate 1: Canvas | Substrate 2: Canvas |
| Composite C: | Substrate 1: PVC (30%*) | Substrate 2: PVC (30%*) |
| Composite D: | Substrate 1: PVC (30%*) | Substrate 2: PVC (30%*) |
| Composite E: | Substrate 1: Canvas | Substrate 2: Canvas |
| Composite F: | Beech/rigid PVC film | |

*Plasticiser content 30%

The Following Test Values were Obtained:

| | Peel strength | | | | | | Heat resistance [° C.] | | |
|---|---|---|---|---|---|---|---|---|---|
| Com- | [N/mm] | | | | | | Softening | | Heat |
| pos- | immediately | | | after 3 days | | | point | | resistance |
| ite | A | B | C | A | B | C | D | E | F |
| Adhe- | | | | | | | | | |
| sive | | | | | | | | | |
| 1a | 3.7 | 3.3 | 1.6 | 4.2 | 5.2 | 11.2 | 106 | >150 | 120 |
| 1b | 4 | 1.7 | 1.2 | 5.9 | 3.4 | 7.7 | 88 | >150 | >120 |
| 2 | 3.4 | 3.8 | 1.4 | 5.5 | 4.6 | 4.2 | 53 | 64 | 90 |
| 2a | 3.2 | 2.3 | 1.7 | 3.8 | 4.4 | 9.3 | 106 | 129 | >120 |
| 2b | 3.1 | 1.1 | 1.5 | 3.8 | 3.3 | 8.4 | 106 | >150 | >120 |
| 3a | 3.8 | 2 | 1.4 | 4.8 | 4.5 | 11.4 | 87 | >150 | >120 |
| 3b | 3.3 | 3.1 | 1.1 | 3.5 | 4.4 | 6.6 | 96 | >150 | >120 |
| 4 | 1.8 | 2.9 | 1.8 | 1.3 | 5.9 | 6.5 | 49 | 56 | 110 |
| 4a | 2.7 | 2.6 | 2 | 3.6 | 4.5 | 10.8 | 84 | >150 | >120 |
| 4b | 2.5 | 1.3 | 1.6 | 3.8 | 3.4 | 8.9 | 103 | >150 | >120 |
| 5a | 2.5 | 4.2 | 3.7 | 4.4 | 4.8 | 16.5 | 69 | 83 | 90 |
| 5b | 3.7 | 4.2 | 3.5 | 6.2 | 5.3 | 14.5 | 106 | 145 | 100 |
| 6 | 1.8 | 4.7 | 1.2 | 1.7 | 1.5 | 2 | 20 | 20 | 50 |
| 6a | 2.3 | 2.2 | 1.5 | 2.6 | 2.2 | 3.4 | 47 | 46 | 60 |
| 6b | 2.6 | 2.2 | 2.1 | 2.8 | 3 | 5.2 | 65 | 80 | 80 |
| 7 | 1.8 | 4.7 | 1.2 | 1.4 | 4.6 | 2.4 | 54 | 59 | 70 |
| 7a | 2.6 | 3.4 | 2.4 | 3.3 | 4.4 | 6.5 | 81 | 139 | 100 |
| 7b | 2.6 | 3.2 | 2.9 | 3.4 | 3.1 | 12.6 | 112 | 122 | 120 |
| 8 | 2.1 | 2.1 | 2.0 | 2.4 | 4.4 | 4.1 | 55 | 59 | 70 |
| 8a | 2.4 | 4.4 | 4.2 | 1.9 | 4.1 | 15.9 | 77 | 140 | 100 |
| 8b | 2.1 | 4.1 | 4.5 | 2.1 | 4.1 | 16.2 | 107 | 142 | 120 |
| 9 | 2.3 | 3.6 | 2.1 | 2.1 | 2.9 | 6.7 | 57 | 62 | 80 |
| 9a | 2.4 | 3.7 | 5.2 | 2.3 | 4.3 | 15.4 | 81 | 143 | 110 |
| 9b | 3.2 | 4.1 | 4.1 | 3.8 | 3.5 | 16.1 | 107 | 141 | >120 |

The values clearly show the very good crosslinking of the dispersion polymers. The added amounts of 5 or 10% carbodiimide crosslinker lead in all cases to markedly improved peel strengths and heat resistance values in the bonded joints.

The adhesive values overall are very high. The binders or binder combinations according to the invention allow high-grade bonded joints to be produced.

By selecting an optimum amount of crosslinker, the bonded joints can be optimised for a particularly high peel strength or a particularly high heat resistance, depending on the requirement.

The adhesive values are on a par with the adhesive values of a dispersion polymer crosslinked with polyisocyanate.

### Comparative Example 10

430 g of polyester I are dehydrated at 110° C. and under 15 mbar for 1 hour. 30.7 g of Desmodur® H and 22.6 g of Desmodur® I are added at 60° C. The mixture is stirred at 80 to 90° C. until an isocyanate content of 1.6% is achieved. The reaction mixture is dissolved in 980 g of acetone and cooled to 50° C. A solution of 6.4 g of sodium salt of N-(2-aminoethyl)-2-aminoethanesulfonic acid and 10.2 g of a reaction product in accordance with a Michael addition comprising 1 mol of isophorone diamine and 1.8 mol of acrylic acid [molecular weight 297 g/mol; diamino-functional; acid value=101 mg KOH/g substance] in 46 g of water and 46 g of acetone is added to the homogeneous solution whilst stirring vigorously. After 30 minutes the mixture is dispersed by adding 560 g of water. After separating off the acetone by distillation 5.1 g of emulsifier FD® are added. A solvent-free, aqueous polyurethane-polyurea dispersion is obtained with a solids content of 46 wt. % and an average particle size in the dispersed phase, determined by laser correlation, of 320 nm. The pH is 5.0. The amount of lateral carboxyl groups available for potential crosslinking, defined by the calculated acid value, =6.8 mg KOH/g substance (relative to 100% solids content of the dispersion).

### Comparative Example 11

540 g of polyester I and 51 g of polyester II are dehydrated at 110° C. and under 15 mbar for 1 hour and then 12 g of dimethylol propionic acid are added. 54.8 g of Desmodur® H and 36.2 g of Desmodur® I are added at 60° C. The mixture is stirred at 80 to 90° C. until an isocyanate content of 1.5% is achieved. The reaction mixture is dissolved in 960 g of acetone and cooled to 50° C. A solution of 8.0 g of sodium salt of N-(2-aminoethyl)-2-aminoethanesulfonic acid and 2.4 g of diethylamine in 195 g of water is added to the homogeneous solution whilst stirring vigorously. After 30 minutes the mixture is dispersed by adding 500 g of water. After separating off the acetone by distillation a solvent-free, aqueous polyurethane-polyurea dispersion is obtained with a solids content of 50 wt. % and an average particle size in the dispersed phase, determined by laser correlation, of 280 nm. The pH is 6.6. The amount of lateral carboxyl groups available for potential crosslinking, defined by the calculated acid value, =7.1 mg KOH/g substance (relative to 100% solids content of the dispersion).

The heat resistance is determined as described above by establishing the softening point. Production of the specimens and testing take place in accordance with composite D (PVC) described above. The comparative dispersions 10) and 11) are applied once without crosslinker and once combined with 5 parts of carbodiimide A). This test is a very good measure of the crosslinking reaction. If no crosslinking takes place, there is also no rise in the softening point, resulting in unsatisfactory adhesive properties overall.

The following result is obtained:

100 parts comparative dispersion 10) without crosslinker: softening point=50° C.

100 parts comparative dispersion 10)+5 parts carbodiimide A): softening point=52° C.

100 parts comparative dispersion 11) without crosslinker: softening point=52° C.

100 parts comparative dispersion 11)+5 parts carbodiimide A): softening point=52°

The softening point of the comparative dispersions without crosslinker is in the same region as the softening point of the dispersions according to the invention without crosslinker. In contrast to the dispersions according to the invention, however, addition of the crosslinker to the comparative dispersions results in virtually no rise in the softening point, and no crosslinking takes place with the lateral carboxyl groups in the comparative dispersion. By contrast, dispersions 1) to 9) according to the invention exhibit a marked rise in the softening point after addition of a crosslinker, and the desired crosslinking reaction takes place.

Test of the Pot Life/Processing Time of the Binder Combinations According to the Invention

Adhesive Formulations:

| No. | Binder combination |
|---|---|
| 1b, fresh mixture | 100 parts dispersion from ex. 1 + 10 parts |
| | carbodiimide crosslinker A) |
| 1b, 1-month-old mixture | 100 parts dispersion from ex. 1 + 10 parts |
| | carbodiimide crosslinker A) |
| 1b, 2-month-old mixture | 100 parts dispersion from ex. 1 + 10 parts |
| | carbodiimide crosslinker A) |

| | | |
|---|---|---|
| Composite A: | Substrate 1: Leather | Substrate 2: Leather |
| Composite B: | Substrate 1: Canvas | Substrate 2: Canvas |
| Composite C: | Substrate 1: PVC (30%*) | Substrate 2: PVC (30%*) |
| Composite D: | Substrate 1: PVC (30%*) | Substrate 2: PVC (30%*) |
| Composite E: | Substrate 1: Canvas | Substrate 2: Canvas |
| Composite F: | Beech/rigid PVC film | |

*Plasticiser content 30%

Both the 1-month-old adhesive formulation and the 2-month-old adhesive

| | | | | | | | Heat resistance | | |
|---|---|---|---|---|---|---|---|---|---|
| | | | | | | | [° C.] | | |
| | | | | | | | Soften- | | Heat |
| | Peel strength [N/mm] | | | | | | ing | | resis- |
| | immediately | | | after 3 days | | | point | | tance |
| Composite | A | B | C | A | B | C | D | E | F |
| Adhesive | | | | | | | | | |
| formu- | | | | | | | | | |
| lation | | | | | | | | | |
| 1b, fresh | 4 | 1.7 | 1.2 | 5.9 | 3.4 | 7.7 | 88 | >150 | >120 |
| mixture | | | | | | | | | |
| 1b, 1- | 2.2 | 3.2 | 1.9 | 1.3 | 5.2 | 10.3 | 106 | >150 | 110 |
| month-old | | | | | | | | | |
| mixture | | | | | | | | | |
| 1b, 2- | 3 | 3.2 | 2.6 | 4.3 | 4.4 | 12.8 | 100 | 146 | 110 |
| month-old | | | | | | | | | |
| mixture | | | | | | | | | |

formulation still exhibit excellent adhesive properties after application.

The binder combinations according to the invention thus allow the production of adhesives, in particular of heat-activated adhesives, which achieve the standard of properties of two-component adhesives conventionally having a pot life of a few hours, and which at the same time because of their very long pot life are comparable to one-component adhesives in terms of their handling. An excellent standard of properties which has hitherto been unknown has thus been achieved.

1-15. (canceled)

16. An aqueous polyurethane or polyurethane-urea dispersion comprising a polyurethane or a polyurethane polyurea dispersed therein, wherein the polyurethane or polyurethane polyurea comprises terminal carboxyl groups and lateral sulfonate and/or carboxylate groups.

17. The aqueous polyurethane or polyurethane-urea dispersion according to claim 16, wherein the polyurethane or polyurethane polyurea comprises terminal carboxyl groups and sulfonate groups, wherein at least 70 mol % of the sulfonate groups are lateral.

18. The aqueous polyurethane or polyurethane-urea dispersion according to claim 16, wherein the polyurethane or polyurethane polyurea comprises terminal carboxyl groups and carboxylate groups, wherein at least 50% of the carboxylate groups are lateral.

19. The aqueous polyurethane or polyurethane-urea dispersion according to claim 16, wherein the polyurethane or polyurethane polyurea comprises terminal carboxyl groups, carboxylate groups, and sulfonate groups, wherein at least 50% of the carboxylate groups and sulfonate groups are lateral,

20. The aqueous polyurethane or polyurethane-urea dispersion according to claim 16, wherein the polyurethane or polyurethane polyurea is obtained by reacting components consisting of
a) at least one component comprising sulfonate and/or carboxylate groups, and comprising two or three isocyanate-reactive hydroxyl and/or amino groups,
b) at least one diol and/or polyol component,
c) at least one di- and/or polyisocyanate component,
d) at least one aminocarboxylic acid and/or hydroxycarboxylic acid, comprising only one hydroxyl or amino group,
e) optionally mono-, di- and/or triamino- and/or hydroxy-functional compounds and
f) optionally other isocyanate-reactive compounds.

21. The aqueous polyurethane or polyurethane-urea dispersion according to claim 20, wherein component a) is used in an amount of from 0.5 to 10 wt. %, component b) in an amount of from 20 to 94 wt. %, component c) in an amount of from 5 to 60 wt. %, component d) in an amount of from 0.25 to 10 wt. %, component e) in an amount of from 0 to 10, and component f) in an amount of from 0 to 20 wt. %, relative to the polyurethanes or polyurethane polyureas.

22. The aqueous polyurethane or polyurethane-urea dispersion according to claim 20, wherein component a) comprises N-(2-aminoethyl)-2-aminoethanesulfonate or dimethylol propionate.

23. The aqueous polyurethane or polyurethane-urea dispersion according to claim 20, wherein component d) consists of aminocarboxylic acids.

24. A process for producing the aqueous polyurethane or polyurethane-urea dispersion according to claim 20, comprising
a. reacting components a), b), c) and optionally f) in a single-stage or multistage reaction to form an isocyanate-functional prepolymer,
b. reacting the prepolymer with component d) and optionally e) in a one- or two-stage reaction
c. dispersing in or with water, and
d. optionally partially or completely removing a solvent, if present, by distillation during or after dispersing.

25. A binder combination for coating compound, adhesive and/or sealant applications wherein the binder combination comprises
i) the polyurethane or polyurethane-urea dispersion according to claim 16.

26. A binder combination according to claim 25, wherein the binder combination further comprises
ii) at least difunctional crosslinkers comprising carboxyl-reactive groups selected from the group consisting of carbodiimides, aziridines, and epoxides.

27. The binder combination according to claim 26, wherein the binder combination comprises from 75 to 99 wt. % of i) and from 1 to 25 wt. % of ii), and wherein the carboxyl-reactive groups are carbodiimide groups.

28. The binder combination according to claim 26, wherein the at least one crosslinker comprises aqueous non-ionically hydrophilised, cycloaliphatic carbodiimides having a carbodiimide equivalent weight of about 385.

29. A method comprising bonding and/or coating and/or lacquering a substrate with a composition which comprises the binder combination according to claim 26.

30. A coated or bonded substrate comprising the binder combination according to claim 26.
